(19) United States
(12) Patent Application Publication
(10) Pub. No.: US 2007/0278768 A1
(43) Pub. Date: Dec. 6, 2007

(54) System combining a foldable wheeled cart and removable cloth bag

(76) Inventor: Timothy B. Lynam, Whitehouse Station, NJ (US)

Correspondence Address: BAKER BOTTS L.L.P., 30 ROCKEFELLER PLAZA, 44TH FLOOR, NEW YORK, NY, 10112-4498, US

(21) Appl. No.: 11/444,762

(22) Filed: Jun. 1, 2006

(51) Int. Cl. B62B 1/00

(52) U.S. Cl. 280/651

(57) ABSTRACT

The present invention provides a foldable wheeled cart system and a removable cloth bag. The wheeled cart system consists of a lightweight frame assembly and a detachable cloth bag that is secured to the frame assembly using, for example, Velcro strips positioned on the handles of the cloth bag. When the bag is removed from the frame assembly, the user may utilize the bag to transport goods independent of the frame assembly. The wheeled cart system may be folded for easy transport and storage. The present invention provides for improved control and maneuverability for a child user and avoids the dangers associated with conventional child shopping carts. In particular, the push handle and multidirectional front wheels allow even very small children such as toddlers to safely participate in the shopping experience with a feeling of independence.

### BACKGROUND OF INVENTION

The present invention relates to a cart apparatus, and more particularly to a wheel-based structure housing a dual-function bag.

Children enjoy accompanying their parents or caregivers to the store. Oftentimes, however, a toddler or small child will want to help the adult direct the cart but is too small to reach the handle. To remedy this problem, child-size shopping carts have been created that allowed for children to navigate a store while pushing a wheeled cart. Typically, these carts are modeled after full-size adult carts and are made of a metal mesh material. These conventional carts pose a risk to young children due to their bulky nature and the fact that they are not easily maneuvered or controlled by children. Furthermore, conventional child carts are heavy and the child oftentimes requires the assistance of an adult to navigate the cart. A need therefore exists for a child shopping cart that is safe and that maximizes the child's feeling of independence during use.

Known children's carts exist that are essentially smaller versions of the metal carts available for adult use in shopping centers and grocery stores. These carts may include a mechanism for wheeling the cart, usually in the form of four wheels. These traditional carts are bulky, inflexible pieces that do not allow the child to use the cart outside of the shopping trip. Furthermore, known children's carts necessitate that the goods placed in the cart be transferred to another container or location following payment for the goods by the adult. A need therefore exists for a cart that allows a more continuous shopping experience for the child and does not require that the child's involvement in the shopping trip end after purchases have been made.

### SUMMARY OF THE INVENTION

An object of the present invention is to overcome the disadvantages of the prior art by providing a system combining a wheeled cart function and a dual-function cloth bag designed for easy and practical use by a child.

In order to meet this and other objects of the present invention which will become apparent with reference to further disclosure set forth below, the present invention provides a system for combining a foldable wheeled cart with a removable cloth bag. In accordance with an exemplary embodiment of the present invention, the frame of the wheeled cart is manufactured using lightweight aluminum, but may alternatively be manufactured using any comparable material. The frame has two main axes that are connected at a center joint which allows the cart to be collapsed when not in use. The cart uses a minimal amount of lightweight metal material in the construction of the frame of the cart. Since the cart of the present invention provides a method for transporting and storing the child cart, the disadvantages associated with traditional child shopping cart are alleviated.

In accordance with an exemplary embodiment of the present invention, the cart uses a cloth bag that may be positioned on the lightweight frame. The bag attaches to the metal frame at the top of each of the two metal components using Velcro. When it is attached to the frame, the cloth bag is maintained in an open position, which allows a child to use the extended cart for shopping. The child may then disengage the Velcro portions of the cloth bag in order to remove the bag from the frame of the cart, thereby allowing the child to carry the bag while it contains groceries or other items.

Additionally, the cart in this exemplary embodiment eliminates the need for use of dangerous and bulky traditional shopping carts by the child. The foldable nature of the cart allows a user to transport the cart at will, thereby ensuring that the child can use a safe and practical shopping cart each time a trip to the store is necessary.

Furthermore, in accordance with a preferred exemplary embodiment of the present invention, the cloth bag may be removed from the frame of the cart and used as a carrying bag. The bag is manufactured with cloth handles on each end to facilitate use by the child when the bag is not affixed to the frame of the cart. The present invention further provides for a bag manufactured from cotton or canvas or any other comparable material. The cloth material of the bag ensures that the bag is machine-washable and therefore appropriate for repeated use by children.

Moreover, in another preferred embodiment of the present invention, the cloth bag may contain any number of pockets or compartments created using additional cloth material. The cloth bag also contains one or more pockets along the bottom of the bag, in which are placed one or more corresponding flat pieces of plastic or cardboard or any other suitable material. This creates a flat bottom in the cloth bag, thereby enabling a child to places items upright in the bottom of the bag when using the cart.

Finally, the use of the cart provides children with a way to independently maneuver a cart in the store. This eliminates the need for a parent or caregiver to constantly assist the child with his or her cart. Furthermore, the removable nature of the cloth bag allows the child to help the adult carry groceries or other items at the end of the shopping trip. The collapsible nature of the lightweight metal frame ensures that the cart may be used by the child in any situation, as it may be easily transported, for example, in a car or by hand.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a block diagram depicting a side view of a wheeled cart system to which the cloth bag is affixed, in accordance with an exemplary embodiment of the present invention;

FIG. 2 is a functional diagram depicting a side view of the wheeled cart system of FIG. 1 in its folded position, in accordance with an exemplary embodiment of the present invention;

FIG. 3 is a functional diagram depicting a side view of the wheeled cart system in the absence of the cloth bag, in accordance with an exemplary embodiment of the present invention;

FIG. 4 is a functional diagram depicting a side view of the cloth bag of FIG. 1 as it exists separate from the wheeled cart system.

Throughout the figures, unless otherwise stated, the same reference numerals and characters are used to denote like features, elements, components, or portions of the illustrated embodiments.

### DETAILED DESCRIPTION OF THE INVENTION

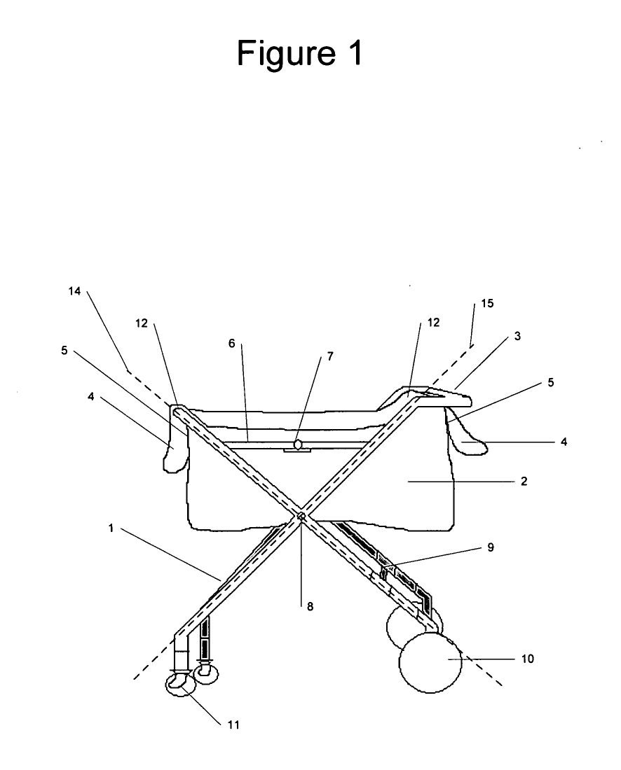

FIG. 1 depicts a side view of a wheeled cart system, in accordance with an exemplary embodiment of the present invention.

A foldable wheeled cart system includes a frame assembly 1 and a removable cloth bag 2. The frame assembly 1 is preferably made of a strong lightweight metal such as aluminum, but alternatively can be made of copper, plastic or any other comparable material. The cloth bag 2 is preferably made of cotton, canvas, denim, or polyester but may alternatively be manufactured from any comparable fabric. The wheeled cart system also includes a push handle 3 which facilitates use by a child. Handles 4 are provided on either side of the cloth bag 2 which allow a user to carry the bag 2 when it is detached from the frame assembly 1. When the cloth bag 2 is attached to the frame assembly 1, the handles 4 of the bag 2 loop over the horizontal bars 12 of the frame assembly 1. In a preferred embodiment of the present invention, the cloth bag 2 is secured to the frame assembly 1 using Velcro strips 5 located on the surface of the cloth bag 2. However, comparable fasteners, such as snaps or buttons, may alternatively be used to secure the cloth bag 2 to the frame assembly 1.

The frame assembly 1 may be folded by disengaging the locking brace 6 that extends from a first axis 14 to a second axis 15 on the frame assembly 1. This may be accomplished by applying manual downward pressure to the center of the locking braces 6 in order to initiate the folding motion. The locking braces 6 collapse at a center joint 7 located at the midsection of each locking brace 6. Disengagement of the locking braces 6 allows for the collapse of the frame assembly 1 by rotational joints 8 located on each face of the wheeled cart system at the intersection of the first and second axes 14, 15 of the frame assembly 1. By applying manual pressure to the horizontal bars 12 of the frame assembly 1, the user is able to collapse the lightweight frame assembly 1 such that it is nearly flat.

The wheeled cart system is mobile. In a preferred embodiment of the present invention, two different sizes of wheels are utilized for maximum control and maneuverability. The wheeled cart system possesses larger wheels 10 (e.g. approximately 4 inches in diameter) at the rear of the cart below the push handle 3. In the front of the wheeled cart system, smaller, multidirectional wheels 11 (e.g. approximately 1 inch in diameter) are mounted on the frame assembly 1 in order to provide maximum steering capability to the child user. A support bar 9 extends between the two larger wheels 10 at the rear of the cart when the cart is in its fully extended, ready-for-use position.

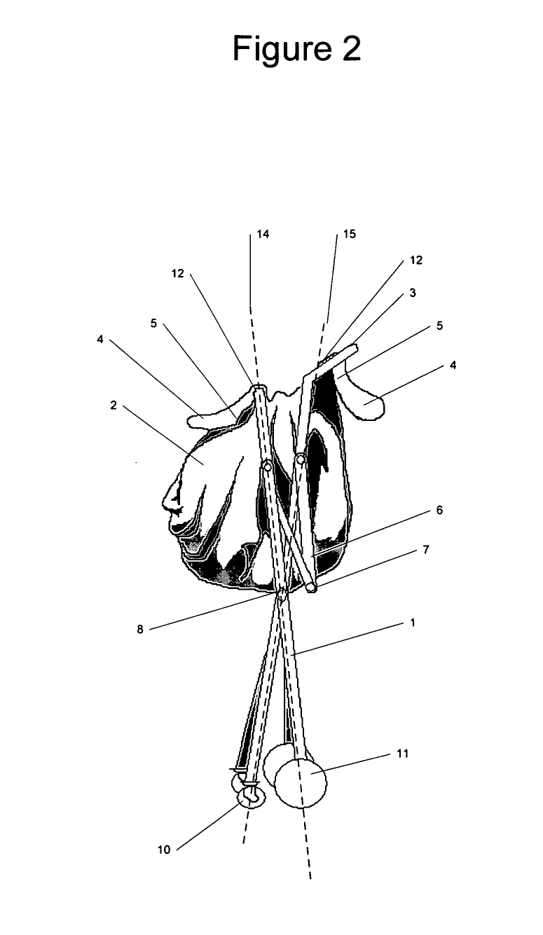

FIG. 2 depicts a side view of the wheeled cart system in its folded position, in accordance with an exemplary embodiment of the present invention. In a preferred embodiment of the present invention, the wheeled cart system may be stored or transported in a nearly flat position. Also in a preferred embodiment of the present invention, the folded position necessitates disengagement of the locking braces 6 of the frame assembly 1. The side view of FIG. 2 shows one of the locking braces 6 in its unlocked position; the locking braces 6 fold downward as the horizontal bars 12 of the frame assembly 1 are brought in close proximity to facilitate folding of the wheeled cart system. The rotational joints 8 of the frame assembly 1 allow for the folding of the wheeled cart system. In its folded configuration, the larger wheels 10 extend beyond the smaller, multidirectional wheels 11 when the wheeled cart assembly 1 is folded to the maximum extent possible. The horizontal bars 12 of the frame assembly 1 rest in close proximity to one another when the wheeled cart system is in its folded state.

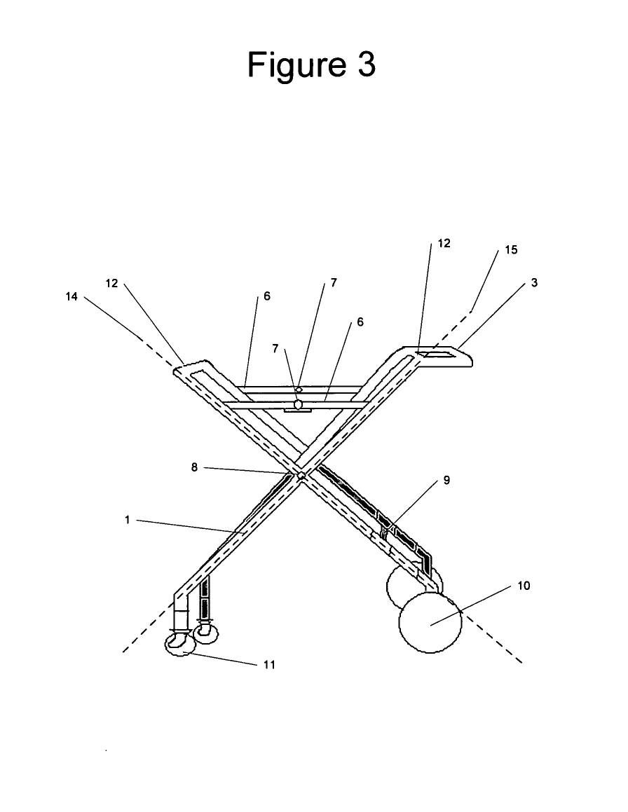

FIG. 3 depicts a side view of the wheeled cart system in the absence of the cloth bag 2, in accordance with an exemplary embodiment of the present invention. FIG. 3 shows the presence of two locking braces 6, one on each face of the wheeled cart system. Further, the push handle 3 is located in proximity to one of the two horizontal bars 12.

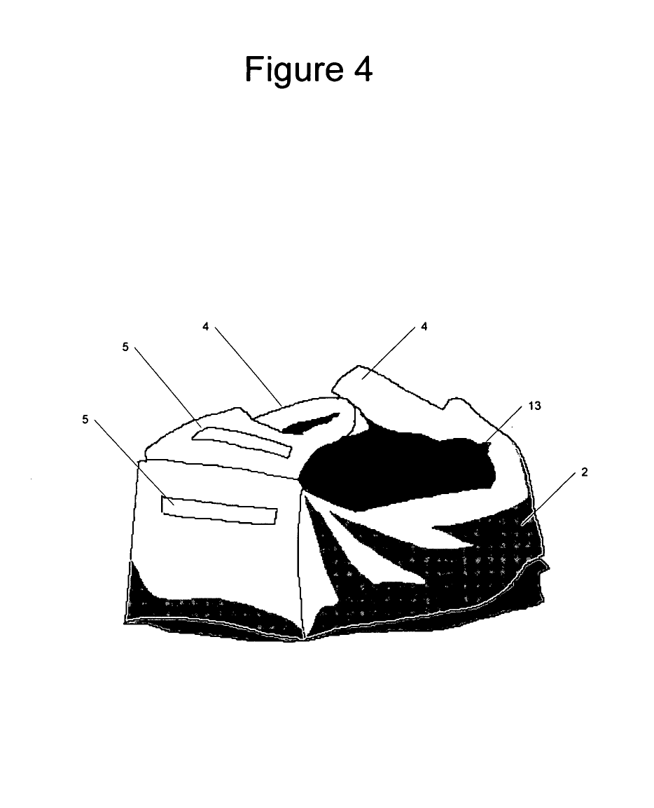

FIG. 4 depicts a side view of the cloth bag 2 as it exists separate from the wheeled cart system, in accordance with an exemplary embodiment of the present invention. When the bag 2 is filled with items, it may be disengaged from the frame assembly 1 and used to independently carry the items. The cloth bag 2 is disassociated from the frame assembly 1 by detaching the Velcro strips 5 on the bag 2 from one another and removing the handles 4 from around the horizontal bars 12 of the frame assembly 1. The cloth bag 2 possesses two handles 4 which allow for a user to transport the bag 2.

FIG. 4 illustrates the placement of two matching Velcro strips 5, which are fastened together following securing of the handles 4 around the horizontal bars 12 of the frame assembly. The cloth bag 2 further possesses an inner chamber 13 which may be filled with items such as those obtained at the grocery store, but may alternatively be used to carry any type of goods. The cloth bag 2 further has one or more pockets contained in its bottom surface for the purpose of receiving one or more corresponding flat pieces of plastic or cardboard such that the cloth bag 2 has a flat bottom on which to place items and such that the cloth bag 2 may be folded.

The foregoing merely illustrates the principles of the invention. Various modifications and alterations to the described embodiments will be apparent to those skilled in the art in view of the teachings herein. For example, one of ordinary skill in the art may consider modifications such as a non-chamfered edge, other types of materials suitable for use in the tubing, and non-circular sink inserts. It will thus be appreciated that those skilled in the art will be able to devise numerous techniques which, although not explicitly described herein, embody the principles of the invention and are thus within the spirit and scope of the invention.

I claim:

1. A wheeled cart for permitting a user to load and carry items in a removable bag, comprising:
a foldable frame assembly including at least two first and second axis portions and a joint portion between said axes;
a locking brace, adapted to releasably connect said first and said second axis portions to said frame assembly to lock said assembly in an open position;
a cloth bag adapted to carry items, removably attached to said frame assembly; and
at least two wheels attached to said frame assembly to permit locomotion thereof.

2. A system as recited in claim 1, wherein said frame assembly is collapsible by release of said locking brace.

3. A system as recited in claim 1, wherein said locking brace further comprises a locking joint adapted for movement in order to release said locking brace.

4. A system as recited in claim 1, further comprising a rotational joint coupled to and located between said first and second axes for facilitating collapse of said frame assembly.

5. A system as recited in claim 1, further comprising a support bar coupled to said frame assembly for stabilizing said frame assembly.

6. A system as recited in claim 1, wherein said first and second axis portions further comprise first and second ends.

7. A system as recited in claim 1, wherein said cloth bag includes two or more handles.

8. A system as recited in claim 6, wherein said first ends of said first and second axes further comprise a means for receiving said handles of said cloth bag.

9. A system as recited in claim 8, wherein said means for receiving said handles of said cloth bag comprises horizontal bars extending from the body of said frame assembly.

10. A system as recited in claim 7, wherein said handles include means for removably attaching to said receiving means of said end of said first axis or an end of said second axis of said frame assembly.

11. A system as recited in claim 10, wherein said means for removably attaching said cloth bag to said frame assembly comprises Velcro strips.

12. A system as recited in claim 1, wherein said cloth bag is manufactured from one of the group consisting of: cotton, canvas, denim, or polyester.

13. A system as recited in claim 1, wherein said cloth bag includes at least one pocket on the bottom interior surface for receiving at least one flat piece.

14. A system as recited in claim 1, wherein said cloth bag includes compartment means for accommodating items.

15. A system as recited in claim 1, wherein two of said two or more wheels comprise multidirectional wheels for enabling the navigation of said wheeled cart.

16. A system as recited in claim 15, wherein said multidirectional wheels are positioned opposite of a push handle.

17. A system for creating a foldable wheeled cart system for permitting a user to utilize a cloth bag either in conjunction with or separate from a lightweight frame assembly, comprising
a foldable frame assembly means including at least two first and second axes portions;
a locking means, adapted to releasably connect said first and said second axes portions to said frame assembly means to lock said assembly means in an open position;
a cloth bag, removably attached to said frame assembly means; and
at least two wheels attached to said frame assembly means to permit locomotion thereof.
